(19) United States
(12) Patent Application Publication
(10) Pub. No.: US 2024/0299870 A1
(43) Pub. Date: Sep. 12, 2024

(54) SEAMLESS FILTRATION MEDIA AND METHODS OF USE

(71) Applicant: Porex Technologies Corporation, Colonial Heights, VA (US)

(72) Inventors: David Bradley HARRIS, Midlothian, VA (US); Janie Molver WIERZBICKI, Richmond, VA (US); Qiang ZHOU, Moseley, VA (US); Michael Wayne SPENCER, Chesterfield, VA (US); Judith Lee SEBASTIAN, Sharpsburg, GA (US)

(73) Assignee: Porex Technologies Corporation, Colonial Heights, VA (US)

(21) Appl. No.: 18/264,718

(22) PCT Filed: Feb. 8, 2022
(86) PCT No.: PCT/US2022/015587

§ 371 Date: Aug. 8, 2023

Related U.S. Application Data
(60) Provisional application No. 63/261,503, filed on Sep. 22, 2021.
(60) Provisional application No. 63/146,862, filed on Feb. 8, 2021.

(51) Int. Cl. B01D 39/16

(52) U.S. Cl. CPC B01D 39/163; B01D 2239/0216; B01D 2239/0428; B01D 2239/0622; B01D 2239/1216

(57) ABSTRACT

The instant disclosure is directed to seamless filtration media and methods for their use. A medium may comprise at least one seamless filtration component, which may comprise a plurality of bonded polymeric fibers and have a porosity from about 60% to about 95%. The medium may comprise multiple, concentrically arranged seamless filtration components, each having a hollow cylindrical configuration. A method of filtering a fluid stream may comprise placing such a medium in the fluid stream, thereby removing particles from the fluid stream. The at least one seamless filtration component of the medium may comprise a plurality of bonded polymeric fibers and have a porosity from about 60% to about 95%. The fluid stream may have a temperature of up to about 150° C. and the particles may have an average diameter from about 0.1 μm to about 5 μm. The fluid stream may be located within a CCV system.

### CROSS-REFERENCE TO RELATED APPLICATIONS

This application claims priority to and benefit of U.S. Provisional Patent Application No. 63/146,862, entitled “Seamless Filtration Media and Methods of Use,” filed Feb. 8, 2021, the disclosure of which is incorporated by reference herein in its entirety. This application further claims priority to and benefit of U.S. Provisional Patent Application No. 63/261,503, entitled “Seamless Filtration Media and Methods of Use,” filed Sep. 22, 2021, the disclosure of which is incorporated by reference herein in its entirety.

### TECHNICAL FIELD

The present disclosure is related to seamless filtration media, their components, and methods of using such media. More particularly, the present disclosure is related to filtration media having high thermal tolerance levels for filtering fluid streams.

### BACKGROUND

Ventilation and filtration systems, particularly within the automotive industry, frequently benefit from streamlined designs. Of particular importance in this field is a design that is efficient, has a high temperature tolerance, and is flexible and compact enough to fit within tight engine compartments. It remains difficult to find filtration media and assemblies that have these features and yet maintain sufficient mechanical strength and filtration efficiency to be effective in the fluid streams in which they are placed. Therefore, there exists a need for filtration media that are flexible and compact, yet efficient and tolerant of temperatures up to 150° C.

### SUMMARY

The instant disclosure is directed to seamless filtration media and methods for their use. In an embodiment, a medium may comprise at least one seamless filtration component. The at least one seamless filtration component may comprise a plurality of bonded polymeric fibers, and may have a porosity from about 60% to about 95%. In some embodiments, the medium may comprise multiple seamless filtration components, each seamless filtration component having a hollow cylindrical configuration. In certain embodiments, the multiple seamless filtration components may be arranged concentrically.

In an embodiment, a medium may consist essentially of at least one seamless filtration component. The at least one seamless filtration component may consist essentially of a plurality of bonded polymeric fibers, and may have a porosity from about 60% to about 95%. In some embodiments, the medium may consist essentially of multiple seamless filtration components, each seamless filtration component having a hollow cylindrical configuration. In certain embodiments, the multiple seamless filtration components may be arranged concentrically.

In an embodiment, a method of filtering a fluid stream may comprise placing a medium in the fluid stream, the medium comprising at least one seamless filtration component, and thereby removing particles from the fluid stream. The at least one seamless filtration component may comprise a plurality of bonded polymeric fibers, and may have a porosity from about 60% to about 95%. In some embodiments, the fluid stream may have a temperature of up to about 150° C. In an embodiment, the particles may have an average diameter from about 0.1 μm to about 5 μm.

### BRIEF DESCRIPTION OF THE DRAWINGS

FIG. 1 shows an embodiment of a medium comprising a seamless filtration component having a hollow cylindrical configuration and a wall thickness, in accordance with the present disclosure.

FIG. 2 shows an embodiment of a medium comprising three concentrically arranged, seamless filtration components having cylindrical shapes, in accordance with the present disclosure.

FIG. 3 is a schematic illustration of an embodiment of a medium, as described herein, incorporated into an assembly having an inlet, an outlet, and a drain.

FIG. 4 shows the water separation efficiency (% water removed as a function of time) of an embodiment of a medium as described herein (dashed line) as compared to a conventional filtration medium (solid line).

FIG. 5 shows the differential pressure (DP, in kPa, as a function of time) of an embodiment of a medium as described herein (dashed line) as compared to a conventional filtration medium (solid line).

### DETAILED DESCRIPTION

This disclosure is not limited to the particular systems, devices, media, and methods described, as these may vary. The terminology used in the description is for the purpose of describing the particular versions or embodiments only, and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” and “the” include plural references, unless the context clearly dictates otherwise. Thus, for example, reference to a “fiber” is a reference to one or more fibers and equivalents thereof known to those skilled in the art, and so forth.

As used herein, the term “consists of” or “consisting of” means that the device, medium, or method includes only the elements, steps, or ingredients specifically recited in the particular claimed embodiment or claim.

In embodiments or claims where the term “comprising” is used as the transition phrase, such embodiments can also be envisioned with replacement of the term “comprising” with the terms “consisting of” or “consisting essentially of.”

As used herein, the term “fluid” means a liquid or gas. Similarly, the term “fluid stream,” as used herein, refers to a portion of a fluid that is moving or movable. In certain embodiments, a fluid stream may comprise an oil vapor stream.

As discussed herein, there exists a need for filtration media that are flexible and compact, yet efficient and tolerant of temperatures up to 150° C. More particularly, the automotive industry consistently strives to improve its closed crankcase ventilation (CCV) systems. A high-efficiency filtration system, with a high temperature tolerance, provides automakers and designers with flexibility in designing a compact, easily maintained system that fits within tight engine compartments. There remains room for increased temperature tolerance, increased mechanical strength, and increased particulate removal and capacity for CCV systems. Filtration media appropriate for such applications may also be used in other settings, including those that require the separation of oil from water, as well as diesel, compressed natural gas, and other alternative fuel engines.

The media and methods described herein may provide desirable strength, compressibility, and particulate removal capabilities, thus meeting or beating existing filtration media in terms of consistent fractional filtration efficiency, customizable flowrate capabilities, and ultra-fine oil mist and particulate separation with a consistently low pressure drop. Moreover, the media and methods described herein may achieve an oil removal efficiency over 96.4% at 0.4 kPa, and may achieve a thermal tolerance of up to 150° C. In particular, the high thermal tolerance of the media and methods described herein may make direct engine mount and near-engine closed CCV designs possible. In addition, the consistent high fractional efficiency and low pressure drop of the media and methods described herein may reduce the profile of the media (e.g., filters) by up to 37%, making their design more flexible and reducing any associated maintenance costs. Without wishing to be bound by theory, the media and methods described herein may demonstrate desirable strength and compressibility due to thermal bonding and direct formation. Additionally, the media and methods described herein may demonstrate desirable capacity due to high porosity, as well as a low pressure drop due to high porosity and binder-free formation. These effects may be due to, for example, the precise control with which the media and methods described herein are produced.

In an embodiment, a medium may comprise at least one seamless filtration component. In some embodiments, the medium may comprise multiple seamless filtration components (e.g., two seamless filtration components, three seamless filtration components, four seamless filtration components, five seamless filtration components, and so on). A seamless filtration component may have no discernable seams; in other words, it may not be held together or bonded to itself using any adhesive or mechanical interface, for example. In some embodiments, the component or components that make up the seamless filtration component may have been thermally bonded together, thereby providing the seamless configuration.

In some embodiments, the at least one seamless filtration component may comprise a plurality of bonded polymeric fibers. In certain embodiments, the bonded polymeric fibers may comprise melt-blown fibers (i.e., fibers or fiber matrices that are formed by one or more melt-blowing processes, as would be understood by a person skilled in the art). Various processes for forming bonded polymeric fibers, as described herein, are disclosed in references such as U.S. Pat. Nos. 6,103,181, 6,596,049, 6,602,311, 6,616,723, and 6,576,034, each of which is incorporated by reference herein in its entirety.

In certain embodiments, the polymeric fibers may have an average diameter from about 1 μm to about 30 μm. The polymeric fibers may have a diameter of, for example, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, or any range between any two of these values, including endpoints.

In some embodiments, the polymeric fibers may comprise one or more polyamides, one or more polyesters, one or more polyolefins, one or more nylons, or any combination thereof. In certain embodiments, the polymeric fibers may comprise a weight percent (wt %) of one or more polyamides that is from about 20 wt % to about 100 wt %. The polymeric fibers may comprise, for example, about 20 wt % of a polyamide, about 25 wt % of a polyamide, about 30 wt % of a polyamide, about 35 wt % of a polyamide, about 40 wt % of a polyamide, about 45 wt % of a polyamide, about 50 wt % of a polyamide, about 55 wt % of a polyamide, about 60 wt % of a polyamide, about 65 wt % of a polyamide, about 70 wt % of a polyamide, about 75 wt % of a polyamide, about 80 wt % of a polyamide, about 85 wt % of a polyamide, about 90 wt % of a polyamide, about 95 wt % of a polyamide, about 100 wt % of a polyamide, or any range between any two of these values, including endpoints. In certain embodiments, the composition of the polymeric fibers may be optimized to ensure the medium's thermal and chemical compatibilities at elevated temperatures.

In certain embodiments, the polymeric fibers may comprise monocomponent fibers, bicomponent fibers, or any combination thereof. In some embodiments, the polymeric fibers may comprise bicomponent fibers having a core-shell structure, as one skilled in the art would appreciate. In certain embodiments, at least one component of the bicomponent fiber(s) may comprise a polyamide. In an embodiment, at least one component of the bicomponent fibers having a core-shell structure (i.e., the core, the shell, or both) may comprise a polyamide. In certain embodiments, one or more of the monocomponent fibers may comprise a polyamide.

In an embodiment, each seamless filtration component of the medium as described herein may independently have a porosity (i.e., an overall porosity) from about 60% to about 95%. Each seamless filtration component may have a porosity of, for example, about 60%, about 65%, about 70%, about 75%, about 80%, about 85%, about 90%, about 95%, or any range between any two of these values, including endpoints. In an embodiment, the porosity may be configured to minimize fluid flow resistance and optimize the particulate holding capacity of the medium.

In certain embodiments, each seamless filtration component of the medium as described herein may independently comprise pores having an average diameter from about 5 μm to about 50 μm. The average diameter of the pores of each seamless filtration component may be, for example, about 5 μm, about 10 μm, about 15 μm, about 20 μm, about 25 μm, about 30 μm, about 35 μm, about 40 μm, about 45 μm, about 50 μm, or any range between any two of these values, including endpoints.

In some embodiments, each seamless filtration component of the medium as described herein may independently have an inner diameter (ID) from about 15 mm to about 140 mm. The inner diameter may be, for example, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 105 mm, about 110 mm, about 115 mm, about 120 mm, about 125 mm, about 130 mm, about 135 mm, about 140 mm, or any range between any two of these values, including endpoints.

In certain embodiments, each seamless filtration component of the medium as described herein may independently have an outer diameter (OD) from about 25 mm to about 225 mm. The outer diameter may be, for example, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 105 mm, about 110 mm, about 115 mm, about 120 mm, about 125 mm, about 130 mm, about 135 mm, about 140 mm, about 145 mm, about 150 mm, about 155 mm, about 160 mm, about 165 mm, about 170 mm, about 175 mm, about 180 mm, about 185 mm, about 190 mm, about 195 mm, about 200 mm, about 205 mm, about 210 mm, about 215 mm, about 220 mm, about 225, or any range between any two of these values, including endpoints.

In some embodiments, each seamless filtration component of the medium as described herein may independently have a length from about 15 mm to more than about 1,500 mm. The length may be, for example, about 15 mm, about 30 mm, about 45 mm, about 60 mm, about 75 mm, about 90 mm, about 100 mm, about 125 mm, about 150 mm, about 175 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, about 525 mm, about 550 mm, about 575 mm, about 600 mm, about 625 mm, about 650 mm, about 675 mm, about 700 mm, about 725 mm, about 750 mm, about 775 mm, about 800 mm, about 825 mm, about 850 mm, about 875 mm, about 900 mm, about 925 mm, about 950 mm, about 975 mm, about 1,000 mm, about 1,025 mm, about 1,050 mm, about 1,075 mm, about 1,100 mm, about 1,125 mm, about 1,150 mm, about 1,175 mm, about 1,200 mm, about 1,225 mm, about 1,250 mm, about 1,275 mm, about 1,300 mm, about 1,325 mm, about 1,350 mm, about 1,375 mm, about 1,400 mm, about 1,425 mm, about 1,450 mm, about 1,475 mm, about 1,500 mm, greater than about 1,500 mm, or any range between any two of these values, including endpoints. In an embodiment, the length of a seamless filtration component of the medium is about 175 mm.

In some embodiments, one or more of the seamless filtration components may have a hydrophobic surface. In an embodiment, the hydrophobic surface may result from one or more post-treatments that may modify the surface properties of the seamless filtration component. In some embodiments, one or more of the seamless filtration components may have an oleophobic surface. In an embodiment, the oleophobic surface may result from one or more post-treatments that may modify the surface properties of the seamless filtration component.

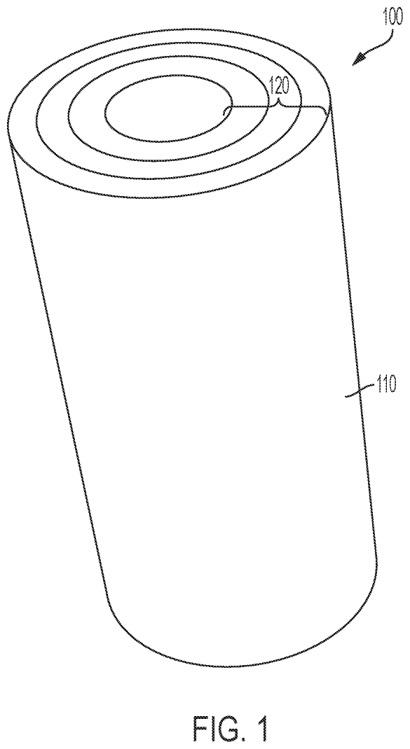

In certain embodiments, each seamless filtration component may have a hollow cylindrical configuration. FIG. 1, for example, shows an embodiment of a medium 100, as described herein. The medium 100 of FIG. 1 comprises a seamless filtration component 110 having a hollow cylindrical configuration and a wall thickness 120. In some embodiments, the wall thickness of a seamless filtration component may be from about 5 mm to about 250 mm. The wall thickness of a seamless filtration component may be, for example, about 5 mm, about 10 mm, about 25 mm, about 50 mm, about 75 mm, about 100 mm, about 125 mm, about 150 mm, about 175 mm, about 200 mm, about 225 mm, about 250 mm, or any range between any two of these values, including endpoints.

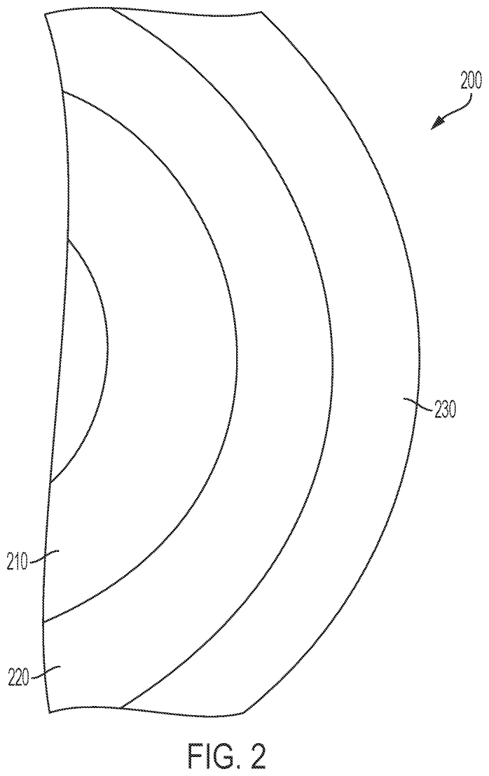

In certain embodiments, the medium may comprise multiple seamless filtration components that are arranged concentrically. FIG. 2, for example, shows an embodiment of a medium 200 comprising a first seamless filtration component 210, a second seamless filtration component 220, and a third seamless filtration component 230. Each of the three seamless filtration components 210, 220, and 230 has a hollow cylindrical configuration, as described herein. The first seamless filtration component 210, the second seamless filtration component 220, and the third seamless filtration component 230 are concentrically arranged. In some embodiments, the three seamless filtration components 210, 220, and 230 have similar or about the same porosity. In some embodiments, the three seamless filtration components 210, 220, and 230 have different porosities. In some embodiments, the porosities of the three seamless filtration components 210, 220, and 230 may be sequentially increased or reduced. For example, the first seamless filtration component 210 may have a higher porosity than the second seamless filtration component 220 and the second seamless filtration component 220 may have a higher porosity than the third seamless filtration component 230. For example, the first seamless filtration component 210 may have a porosity of about 90%, the second seamless filtration component 220 may have a porosity of about 85%, and the third seamless filtration component 230 may have a porosity of about 80%. However, additional porosities and arrangements thereof are contemplated herein as would be apparent to a person having an ordinary level of skill in the art.

In some embodiments comprising multiple seamless filtration components, the seamless filtration components may be arranged such that there are one or more gaps between them, resulting in seamless filtration components that are not in contact with one another. In such embodiments, the one or more gaps between the seamless filtration components may be a distance from about 1 mm to about 10 mm. The distance may be, for example, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, about 10 mm, or any range between any two of these values, including endpoints. In some embodiments, the one or more gaps may exist between two or more concentrically arranged seamless filtration components. In other embodiments, the seamless filtration components may be arranged such that there are no gaps or substantially no gaps between them, resulting in seamless filtration components that are in contact with one another. In some embodiments, the medium may comprise additional structural supports between the seamless filtration components to allow the seamless filtration components to have no contact with one another.

In some embodiments, a medium as described herein may have an inner diameter (ID) from about 15 mm to about 140 mm. The inner diameter may be, for example, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 105 mm, about 110 mm, about 115 mm, about 120 mm, about 125 mm, about 130 mm, about 135 mm, about 140 mm, or any range between any two of these values, including endpoints.

In certain embodiments, a medium as described herein may have an outer diameter (OD) from about 25 mm to about 225 mm. The outer diameter may be, for example, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 105 mm, about 110 mm, about 115 mm, about 120 mm, about 125 mm, about 130 mm, about 135 mm, about 140 mm, about 145 mm, about 150 mm, about 155 mm, about 160 mm, about 165 mm, about 170 mm, about 175 mm, about 180 mm, about 185 mm, about 190 mm, about 195 mm, about 200 mm, about 205 mm, about 210 mm, about 215 mm, about 220 mm, about 225, or any range between any two of these values, including endpoints.

In some embodiments, a medium as described herein may have a length from about 15 mm to more than about 1,500 mm. The length may be, for example, about 15 mm, about 30 mm, about 45 mm, about 60 mm, about 75 mm, about 90 mm, about 100 mm, about 125 mm, about 150 mm, about 175 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, about 525 mm, about 550 mm, about 575 mm, about 600 mm, about 625 mm, about 650 mm, about 675 mm, about 700 mm, about 725 mm, about 750 mm, about 775 mm, about 800 mm, about 825 mm, about 850 mm, about 875 mm, about 900 mm, about 925 mm, about 950 mm, about 975 mm, about 1,000 mm, about 1,025 mm, about 1,050 mm, about 1,075 mm, about 1,100 mm, about 1,125 mm, about 1,150 mm, about 1,175 mm, about 1,200 mm, about 1,225 mm, about 1,250 mm, about 1,275 mm, about 1,300 mm, about 1,325 mm, about 1,350 mm, about 1,375 mm, about 1,400 mm, about 1,425 mm, about 1,450 mm, about 1,475 mm, about 1,500 mm, greater than about 1,500 mm, or any range between any two of these values, including endpoints. In an embodiment, the length of a medium is about 175 mm.

In certain embodiments, a medium as described herein may be configured (e.g., by virtue of its physical properties) to remove particles from a fluid stream. In some embodiments, the particles may have an average diameter from about 0.1 μm to about 5 μm. The particles may have an average diameter equal to or greater than, for example, about 0.1 μm, about 0.5 μm, about 1 μm, about 2 μm, about 3 μm, about 4 μm, about 5 μm or any range between any two of these values, including endpoints. In an embodiment, the average diameter of the particles may be greater than about 2 μm. Moreover, the medium described herein may, in practice, filter out a wide range of particles having diameters across the ranges described above. In an embodiment, the medium described herein may have an average filtration efficiency over 90% based on ISO 17536-5.

In some embodiments, a fluid stream as described herein may have an average temperature of up to about 150° C., meaning that a medium as described herein may maintain its structural integrity and filtration capabilities in an environment that has an average of up to about 150° C. The average temperature may be, for example, up to 150° C., up to 145° C., up to 140° C., up to 135° C., up to 130° C., up to 125° C., up to 120° C., up to 115° C., up to 110° C., up to 105° C., up to 100° C., and so on.

In some embodiments, a medium as described here may be largely free of, or substantially free of, an additive and/or a binder. In certain embodiments, the medium may be entirely free of (i.e., may not comprise) an additive and/or a binder. In some embodiments, one or more of the seamless filtration components may be largely free of, substantially free of, or entirely free of (i.e., may not comprise) an additive and/or a binder.

In certain embodiments, a medium as described herein may further comprise one or more physical supports to optimize the medium for placement within a particular type of fluid stream. In other embodiments, a medium as described herein may be free of additional physical supports (i.e., the medium may be self-supporting).

In an embodiment, a medium as described herein may consist of, or consist essentially of, at least one seamless filtration component, as described herein. The at least one seamless filtration component may consist of, or consist essentially of, a plurality of bonded polymeric fibers, as described herein, and may have a porosity from about 60% to about 95%, as described herein. In some embodiments, the medium may consist of, or consist essentially of, multiple seamless filtration components, each seamless filtration component having a hollow cylindrical configuration, as described herein. In certain embodiments, the multiple seamless filtration components may be arranged concentrically, as described herein.

In an embodiment, a method of filtering a fluid stream may comprise placing a medium as described herein in the fluid stream. The medium may comprise at least one seamless filtration component, as described herein. As described herein, the fluid stream may have an average temperature of up to about 150° C.

In some embodiments, placing the medium in the fluid stream may thereby remove particles from the fluid stream. As described herein, the particles may have an average diameter from about 0.1 μm to about 5 μm.

In certain embodiments, the fluid stream may be located within a closed crankcase ventilation (CCV) or other automotive system, as described herein. In an embodiment, the fluid stream may have a pressure of about 0.4 kPa, and removing the particles from the fluid stream may comprise removing one or more particles at a removal efficiency of greater than about 96.4%. In an embodiment, the particles may comprise oil particles.

In some embodiments, the method may further comprise keeping the medium in the fluid stream for a mileage from about 1 mile to about 25,000 miles. The mileage may be, for example, 1 mile, 10 miles, 100 miles, 1,000 miles, 5,000 miles, 10,000 miles, 15,000 miles, 20,000 miles, 25,000 miles, or any range between any two of these values, including endpoints.

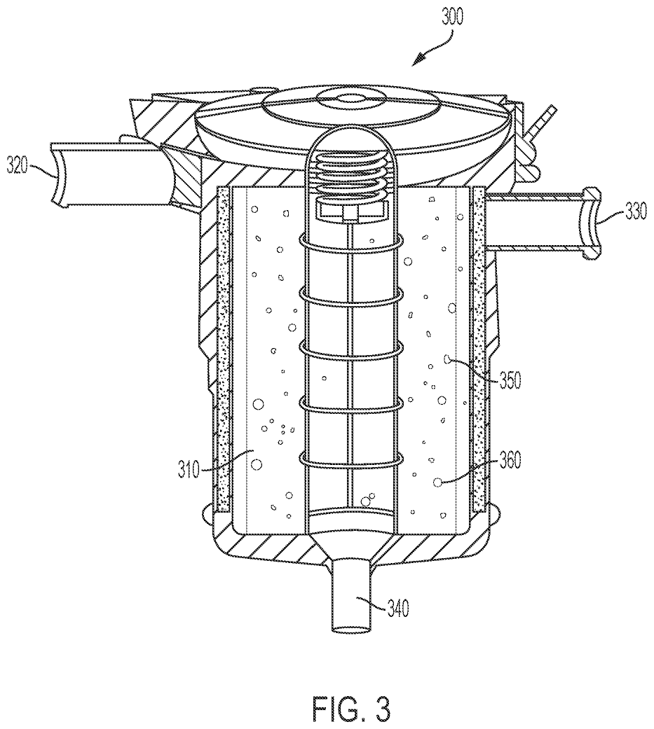

FIG. 3 provides a schematic illustration of an embodiment of a medium 310, as described herein, incorporated into an assembly 300 having an inlet 320, an outlet 330, and a drain 340 (e.g., a diesel water separator, a CCV, and the like). After use in the assembly 300, the medium 310 may contain, for example, particulates/dust 350, fluid droplets 360, or any combination thereof.

Embodiment 1 is a medium comprising: at least one seamless filtration component; wherein the at least one seamless filtration component comprises a plurality of bonded polymeric fibers; and wherein the at least one seamless filtration component has a porosity from about 60% to about 95%.

Embodiment 2 is the medium of embodiment 1, wherein two edges of the seamless filtration component are thermally bonded together to provide a seamless configuration.

Embodiment 3 is the medium of embodiment 1 or 2, wherein the bonded polymeric fibers comprise melt-blown fibers.

Embodiment 4 is the medium of any of embodiments 1-3, wherein the bonded polymeric fibers have an average diameter from about 1 μm to about 30 μm.

Embodiment 5 is the medium of any of embodiments 1-4, wherein the bonded polymeric fibers comprise a polyamide, a polyester, a polyolefin, a nylon, or a combination thereof.

Embodiment 6 is the medium of any of embodiments 1-5, wherein the bonded polymeric fibers comprise from at least 20 wt % of a polyamide to about 100 wt % of a polyamide.

Embodiment 7 is the medium of any of embodiments 1-6, wherein the bonded polymeric fibers comprise monocomponent fibers, bicomponent fibers, or a combination thereof.

Embodiment 8 is the medium of embodiment 7, wherein the bicomponent fibers have a core-shell structure.

Embodiment 9 is the medium of embodiment 7 or 8, wherein at least one component of the bicomponent fibers comprises a polyamide.

Embodiment 10 is the medium of any of embodiment 7-9, wherein the monocomponent fibers comprise a polyamide.

Embodiment 11 is the medium of any of embodiments 1-10, wherein the at least one seamless filtration component comprises pores having an average diameter from about 5 μm to about 50 μm.

Embodiment 12 is the medium of any of embodiments 1-11, wherein the at least one seamless filtration component comprises a hydrophobic surface.

Embodiment 13 is the medium of any of embodiments 1-12, wherein the at least one seamless filtration component comprises an oleophobic surface.

Embodiment 14 is the medium of any of embodiments 1-13, wherein the at least one seamless filtration component has a hollow cylindrical configuration having a wall thickness from about 5 mm to about 250 mm.

Embodiment 15 is the medium of any of embodiments 1-14, wherein the at least one seamless filtration component comprises at least two seamless filtration components having cylindrical configurations, and wherein the at least two seamless filtration components are arranged concentrically.

Embodiment 16 is the medium of embodiment 15, wherein the at least two seamless filtration components are arranged concentrically, and wherein there is a gap between the at least two seamless filtration components, such that the at least two seamless filtration components are not in contact.

Embodiment 17 is the medium of embodiment 16, wherein the gap is from about 1 mm to about 10 mm.

Embodiment 18 is the medium of embodiment 15, wherein the at least two seamless filtration components are arranged concentrically, and wherein there is no space between the at least two seamless filtration components, such that the at least two seamless filtration components are in contact.

Embodiment 19 is the medium of any of embodiments 1-18, wherein the medium does not comprise an additive and/or a glass fiber.

Embodiment 20 is the medium of any of embodiments 1-19, wherein the medium does not comprise a binder.

Embodiment 21 is the medium of any of embodiments 1-20, wherein the medium is configured to remove particles from a fluid stream, and wherein the particles have an average diameter from about 0.1 μm to about 5 μm.

Embodiment 22 is the medium of any of embodiments 1-21, wherein the fluid stream has a temperature of up to about 150° C.

Embodiment 23 is a medium consisting essentially of: at least one seamless filtration component; wherein the at least one seamless filtration component consists essentially of a plurality of bonded polymeric fibers; and wherein the at least one seamless filtration component has a porosity from about 60% to about 95%.

Embodiment 24 is a method of filtering a fluid stream, the method comprising: placing a medium in the fluid stream, the medium comprising: at least one seamless filtration component; wherein the at least one seamless filtration component comprises a plurality of bonded polymeric fibers; and wherein the at least one seamless filtration component has a porosity from about 60% to about 95%; wherein the fluid stream has a temperature of up to about 150° C.; thereby removing particles from the fluid stream.

Embodiment 25 is the method of embodiment 24, wherein the particles have an average diameter from about 0.1 μm to about 5 μm.

Embodiment 26 is the method of embodiment 24 or 25, wherein the fluid stream is located within a closed crankcase ventilation (CCV) system.

Embodiment 27 is the method of any of embodiments 24-26, wherein the fluid stream has a pressure of about 0.4 kPa, and wherein removing particles from the fluid stream comprises removing oil particles at a removal efficiency of greater than 96.4%.

Embodiment 28 is the method of any of embodiments 24-27, further comprising keeping the medium in the fluid stream for a mileage from about 1 mile to about 25,000 miles.

Embodiment 29 is the method of any of embodiments 24-28, wherein two edges of the seamless filtration component are thermally bonded together to provide a seamless configuration.

Embodiment 30 is the method of any of embodiments 24-29, wherein the bonded polymeric fibers comprise melt-blown fibers.

Embodiment 31 is the method of any of embodiments 24-30, wherein the bonded polymeric fibers have an average diameter from about 1 μm to about 30 μm.

Embodiment 32 is the method of any of embodiments 24-31, wherein the bonded polymeric fibers comprise a polyamide, a polyester, a polyolefin, a nylon, or a combination thereof.

Embodiment 33 is the method of any of embodiments 24-32, wherein the bonded polymeric fibers comprise from at least 20 wt % of a polyamide to about 100 wt % of a polyamide.

Embodiment 34 is the method of any of embodiments 24-33, wherein the bonded polymeric fibers comprise monocomponent fibers, bicomponent fibers, or a combination thereof.

Embodiment 35 is the method of embodiment 34, wherein the bicomponent fibers have a core-shell structure.

Embodiment 36 is the method of embodiment 34 or 35, wherein at least one component of the bicomponent fibers comprises a polyamide.

Embodiment 37 is the method of any of embodiments 34-36, wherein the monocomponent fibers comprise a polyamide.

Embodiment 38 is the method of any of embodiments 24-37, wherein the at least one seamless filtration component comprises pores having an average diameter from about 5 μm to about 50 μm.

Embodiment 39 is the method of any of embodiments 24-38, wherein the at least one seamless filtration component comprises a hydrophobic surface.

Embodiment 40 is the method of any of embodiments 24-39, wherein the at least one seamless filtration component comprises an oleophobic surface.

Embodiment 41 is the method of any of embodiments 24-41, wherein the at least one seamless filtration component has a hollow cylindrical configuration having a wall thickness from about 5 mm to about 250 mm.

Embodiment 42 is the method of any of embodiments 24-41, wherein the at least one seamless filtration component comprises at least two seamless filtration components having cylindrical configurations, and wherein the at least two seamless filtration components are arranged concentrically.

Embodiment 43 is the method of embodiment 42, wherein the at least two seamless filtration components are arranged concentrically, and wherein there is a gap between the at least two seamless filtration components, such that the at least two seamless filtration components are not in contact.

Embodiment 44 is the method of embodiment 43, wherein the gap is from about 1 mm to about 10 mm.

Embodiment 45 is the method of embodiment 42, wherein the at least two seamless filtration components are arranged concentrically, and wherein there is no space between the at least two seamless filtration components, such that the at least two seamless filtration components are in contact.

Embodiment 46 is the method of any of embodiments 24-45, wherein the medium does not comprise an additive.

Embodiment 47 is the method of any of embodiments 24-46, wherein the medium does not comprise a binder.

### Examples

A medium comprising a first seamless filtration component and a second seamless filtration component, as described herein, was tested under an abbreviated ISO 16332:2018 test protocol (testing time was reduced to 50 minutes instead of the full 4 hours provided in the test standard). The first seamless filtration component and the second seamless filtration component each had cylindrical configurations, and were arranged concentrically, as described herein. The first seamless filtration component had an inner diameter (ID) of 48 mm and an outer diameter of 55 mm; the second seamless filtration component had an ID of 55 mm about an OD of 97 mm. The medium had a length of 175 mm. The medium as described herein (“seamless filtration media”) was compared to a conventional filtration medium to evaluate the efficiency with which they separated water from diesel fuel under defined, simple laboratory conditions. The tests were conducted at a flow rate of 25 mL/minute with diesel fuel containing 2736 ppm of water in upstream at room temperature.

Water concentration was measured both upstream and downstream of the filter, and the difference between the measurements was reported as a water separation efficiency. Total water drained from the filter was also measured and compared to total water loaded into the fuel. Differential pressure was also measured at the test filters.

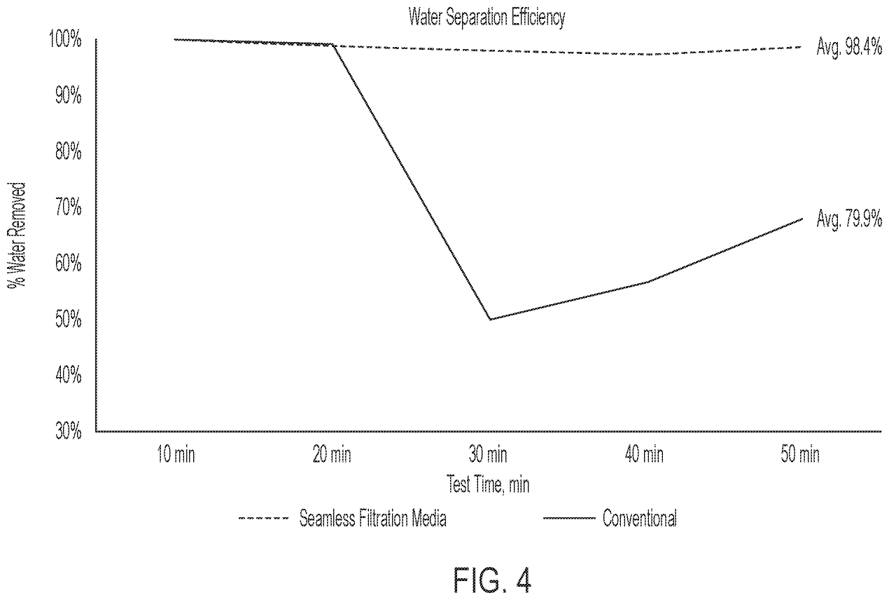

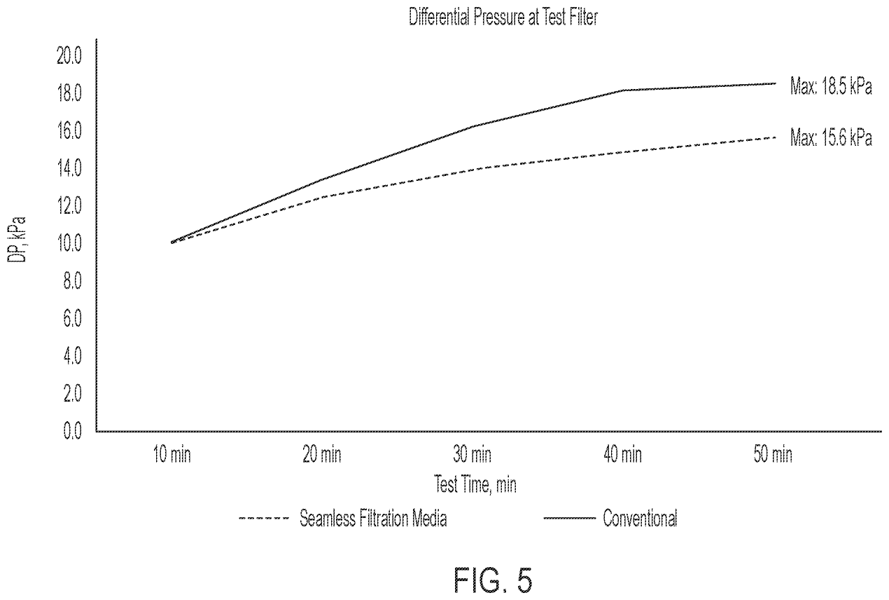

FIG. 4 shows the water separation efficiency (% water removed as a function of time) of the seamless filtration media (dashed line; comprising a first seamless filtration component and a second seamless filtration component, as described herein) as compared to the conventional filtration medium tested (solid line). FIG. 5 shows the differential pressure (DP or ΔP, in kPa, as a function of time) of the seamless filtration media (dashed line; comprising a first seamless filtration component and a second seamless filtration component, as described herein) as compared to the conventional filtration medium tested (solid line). These results are also summarized in Table 1 below.

TABLE 1
Water separation efficiency and differential pressure testing results.

| Sample | ΔP, kPa | 10 min | 20 min | 30 min | 40 min | 50 min | Avg. |
|---|---|---|---|---|---|---|---|
| Seamless | 13.3 | 99.99% | 98.70% | 98.00% | 97.40% | 98.60% | 98.40% |
| filtration | | | | | | | |
| media | | | | | | | |
| Conventional | 14.3 | 99.99% | 99.99% | 29.90% | 56.60% | 68.00% | 70.90% |

These results demonstrate that the media described herein functioned to coalesce the water droplets in the diesel fuel mixture, and allowed them to drop out of solution upon hitting the drainage layer, with greater than 98% water removal efficiency over a 50-minute period. The media described herein removed over 95% of emulsified water particles from diesel fuel during testing. Some samples of the media described herein demonstrated over 99.99% water removal efficiency during initial testing time periods.

Without wishing to be bound by theory, the media described herein are believed to creates a low pressure drop with ultra-high water removal and particulate filtration efficiency. The media described herein are therefore believed to the ultra-high efficiency described herein without increasing the pressure drop across the filter, instead maintaining a consistent low pressure drop. The ultra-high water removal efficiency and low pressure drops allows for flexibility in dimensions, to better optimize footprint more effectively, which may allow for a reduced filter size while maintaining competitive filtration efficiency and pressure drop. The media described herein are also fully customizable to specific dimensional and performance requirements and material compositions. The media as described herein may be used in, for example, diesel water separators, fuel water separators, fuel filters, jet fuel filters, air filtration media (e.g., crankcase ventilation filters), and the like.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and media are described in terms of “comprising” various components or steps (interpreted as meaning “including, but not limited to”), the compositions, methods, and media can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 fibers refers to groups having 1, 2, or 3 fibers. Similarly, a group having 1-5 fibers refers to groups having 1, 2, 3, 4, or 5 fibers, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the claims include equivalents to the recited values, e.g., variations in the numerical quantity of such values that can occur, but would be recognized to be equivalents by a person skilled in the art.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1.-47. (canceled)

48. A medium comprising:
a seamless filtration component;
wherein the seamless filtration component comprises a plurality of bonded polymeric fibers; and
wherein the seamless filtration component has a porosity from about 60% to about 95%.

49. The medium of claim 48, wherein two edges of the seamless filtration component are thermally bonded together to provide a seamless configuration.

50. The medium of claim 48, wherein the bonded polymeric fibers comprise a polyamide, a polyester, a polyolefin, a nylon, or a combination thereof.

51. The medium of claim 48, wherein the bonded polymeric fibers comprise from at least 20 wt % of a polyamide to about 100 wt % of a polyamide.

52. The medium of claim 48, wherein the bonded polymeric fibers comprise monocomponent fibers, bicomponent fibers, or a combination thereof.

53. The medium of claim 48, wherein the seamless filtration component comprises a hydrophobic surface, an oleophobic surface, or a combination thereof.

54. The medium of claim 48, wherein the seamless filtration component has a hollow cylindrical configuration having a wall thickness from about 5 mm to about 250 mm.

55. The medium of claim 48, wherein the seamless filtration component comprises at least two seamless filtration components having cylindrical configurations, and wherein the at least two seamless filtration components are arranged concentrically.

56. The medium of claim 55, wherein there is a gap between the at least two seamless filtration components, such that the at least two seamless filtration components are not in contact.

57. The medium of claim 55, wherein there is no space between the at least two seamless filtration components, such that the at least two seamless filtration components are in contact.

58. The medium of claim 48, wherein the medium is configured to remove particles from a fluid stream, the particles having an average diameter from about 0.1 μm to about 5 μm.

59. The medium of claim 58, wherein the fluid stream has a temperature of up to about 150° C.

60. A method of filtering a fluid stream, the method comprising:
placing a medium in the fluid stream, the medium comprising:
a seamless filtration component;
wherein the seamless filtration component comprises a plurality of bonded polymeric fibers; and
wherein the seamless filtration component has a porosity from about 60% to about 95%;
wherein the fluid stream has a temperature of up to about 150° C.;
thereby removing particles from the fluid stream.

61. The method of claim 60, wherein the particles have an average diameter from about 0.1 μm to about 5 μm.

62. The method of claim 60, wherein the fluid stream is located within a closed crankcase ventilation (CCV) system.

63. The method of claim 60, wherein the fluid stream has a pressure of about 0.4 kPa, and wherein removing particles from the fluid stream comprises removing oil particles at a removal efficiency of greater than 96.4%.

64. The method of claim 60, wherein the bonded polymeric fibers have an average diameter from about 1 μm to about 30 μm.

65. The method of claim 60, wherein the bonded polymeric fibers comprise a polyamide, a polyester, a polyolefin, a nylon, or a combination thereof.

66. The method of claim 60, wherein the bonded polymeric fibers comprise bicomponent fibers having a core-shell structure.

67. The method of claim 60, wherein the seamless filtration component comprises pores having an average diameter from about 5 μm to about 50 μm.
